(19) United States
(12) Patent Application Publication
(10) Pub. No.: US 2026/0093965 A1
(43) Pub. Date: Apr. 2, 2026

(54) SPARSE ACTIVATION-AWARE WEIGHT LOADING AND INFERENCE FOR MACHINE LEARNING MODELS

(71) Applicant: Amazon Technologies, Inc., Seattle, WA (US)

(72) Inventors: Mahdi Heydari, Palo Alto, CA (US); Sankalp Dayal, San Mateo, CA (US); Abhishek Sahadev Sutar, Santa Clara, CA (US); Deepak Shivarudrappa, Fremont, CA (US); Tariq Afzal, San Jose, CA (US); Rahul Bakshi, San Jose, CA (US)

(21) Appl. No.: 18/901,836

(22) Filed: Sep. 30, 2024

(51) Int. Cl. G06N 3/0495

(52) U.S. Cl. CPC G06N 3/0495

(57) ABSTRACT

Devices and techniques are generally described for sparse activation-aware weight loading and inference for machine learning models. In some examples, a first activation tensor may be generated for first input data. A first sparsity map may be generated for the first activation tensor. The first sparsity map may indicate respective positions of zero values and non-zero values in the first activation tensor. A first set of channels of a weight tensor that correspond to respective non-zero values from the first sparsity map may be identified. The first set of channels of the weight tensor may be loaded into memory. A machine learning model may generate output data based on the first set of channels and the first activation tensor.

### BACKGROUND

Machine learning techniques are used to form predictions, solve problems, recognize objects in image data for classification, etc. For example, machine learning techniques may be used to detect objects represented in image data, generate text, images, translate text from one human understandable language to another, etc. In various examples, machine learning models may be improved over time by retraining the models as more or different data becomes available. Accordingly, machine learning techniques are adaptive to changing conditions. Deep learning algorithms, such as neural networks, are sometimes used to detect patterns in data and/or perform tasks.

### BRIEF DESCRIPTION OF DRAWINGS

FIG. 1 is a block diagram of an example machine learning accelerator architecture that may include a sparsity-aware weight packing engine, according to various embodiments of the present disclosure.

FIG. 2 depicts offline model optimization and real-time sparse activation aware processing for machine learning models, according to various aspects of the present disclosure.

FIGS. 3A-3C depict various examples of sparse activation aware weight packing, in accordance with various examples of the present disclosure.

FIG. 4 depicts an example process for sparse activation aware processing for machine learning models, in accordance with various aspects of the present disclosure.

FIG. 5 is a block diagram showing an example architecture of a network-connected device that may be used in accordance with various aspects described herein.

FIG. 6 is a block diagram showing an example architecture of computing devices that may be used in accordance with various aspects described herein.

### DETAILED DESCRIPTION

In the following description, reference is made to the accompanying drawings that illustrate several examples of the present invention. It is understood that other examples may be utilized and various operational changes may be made without departing from the scope of the present disclosure. The following detailed description is not to be taken in a limiting sense, and the scope of the embodiments of the present invention is defined only by the claims of the issued patent.

Artificial intelligence systems including various machine learning models are currently being developed and deployed for a wide variety of use cases, including generative models such as language models (e.g., large language models (LLMs)), image/video generation models (e.g., latent diffusion models), computer vision models, LLM-based agents, neural network-based classifiers, etc. Such machine learning models can be executed on general purpose processors and/or hardware accelerators using program code written in a specialized programming language such as TensorFlow, PyTorch, etc. The program code is converted into machine instructions by a compiler. In a neural network, the types of computations performed, and the data the computations are performed on, can be different from computations used for other things. For example, neural networks can involve repeated manipulation of large quantities of data representing tensors. The term tensor will sometimes be used herein in accord with its mathematical meaning, but will also sometimes be used herein to refer to stored data representing a tensor or a data structure storing data representing a tensor, e.g. a vector, matrix, or larger dimensional data structure. The term channel will sometimes be used herein to refer to a mathematically defined portion of a tensor, e.g. for a three dimensional tensor characterized as having rows, columns, and sheets (the term sheet is used here instead of the sometimes used term “channel” to avoid confusion), the term channel may refer to a row of a single sheet, a row of all sheets, a column of a single sheet, or a column of all sheets.

As used herein, a data structure storing weight values for a particular layer of a machine learning model may sometimes be referred to as a weight tensor. Output from a previous operation may be used with a weight tensor for a current layer (e.g., effecting matrix multiplication) to generate another tensor. An activation function may then be used with another tensor to generate an activation tensor. This activation tensor may then subsequently be used together with another weight tensor, or other intermediate operations may first be performed. Weight values (and bias values) are examples of the learnable parameters of machine learning models. As used herein, weight values include both model weights and bias values.

The sparsity of activation tensors (e.g., the number of zero-valued activations in an activation tensor) is dynamic depending on the relevant layer of the model, the model itself, and the model's input. This is in contrast to the static sparsity of machine learning model weights. Various specialized hardware has been developed to exploit static weight sparsity to reduce the computational load, reduce latency, reduce power consumption, increase throughput, etc. Described herein is various hardware, as well as techniques that may be used to exploit the dynamic sparsity of activation tensors in machine learning models in order to further improve efficiency of machine learning model-based processing (e.g., by reducing the number of compute operations, reducing latency, reducing power consumption, increasing throughput, etc.). The various techniques described herein are particularly important for current and future classes of large models (e.g., machine learning models having billions or trillions of parameters) with performance that is currently both compute and memory bound.

For example, large language models (LLMs) exhibit dynamic sparsity for activation tensors. As described in further detail below, sparsed activation tensors in LLMs (e.g., activation tensors having zero-valued elements) can be exploited during model weight loading in order to reduce the memory footprint and number of compute operations for subsequent model layers that use the sparse outputs. Zero-valued elements of activation tensors do not contribute to the activation and matrix tensor multiplications (as the product of zero and any number is zero). In addition to greatly reducing memory footprint (e.g., by more than 10×), compute may be sped up by O(n²) where

$$n = \frac{activation tensor size}{number of non - zero elements of activation tensor}$$

due to the large reduction in the number of operations that need to be performed.

The various machine learning models described herein may be executed on a combination of physical and/or virtualized computing devices/resources. Physical computing resources may include, for example, hardware compute processing units (CPUs), hardware accelerators (e.g., graphics processing units (GPUs), neural processing units (NPUs), neural network accelerators (NNAs), physical memory, etc. Examples of virtualized computing resources may include virtualized CPUs, GPUs, NNAs, virtual memory, etc. Computing resources may include virtualized components executing on physical hardware. In some examples, the virtualized components and/or the physical hardware on which the virtualized components are executed may be distributed (e.g., geographically diverse). A collection of distributed compute services (e.g., of a given server instance) may be instantiated, for example, using a container orchestration framework, one or more virtual machines, physical hardware, etc. In some other examples, a given server instance may executed on the same hardware components (and may not be distributed). Accordingly, server instances may include components that are physical and/or virtual and which may be distributed and/or co-located. A configuration for a given server instance can refer to the different hardware (whether physical or virtualized) deployed on the server instance, the software deployed on the server instance, and/or the configurations thereof.

In various examples discussed herein, some of the computing devices described herein may be provisioned with and/or may employ accelerator hardware. In some cases, machine learning accelerators (and/or general processors, depending on the implementation) may be programmed to implement an inference engine. An inference engine refers to programming a machine learning accelerator and/or general purpose processor (or processors) to execute the various operations of a particular machine learning model. Examples of such operations may include determining dot products of two vectors, vector addition, vector multiplication, matrix multiplication, forward and backward convolutions, pooling, etc. Inference engines may be implemented using machine learning accelerator hardware and/or other specialized processors (e.g., graphical processing units, tensor processing units).

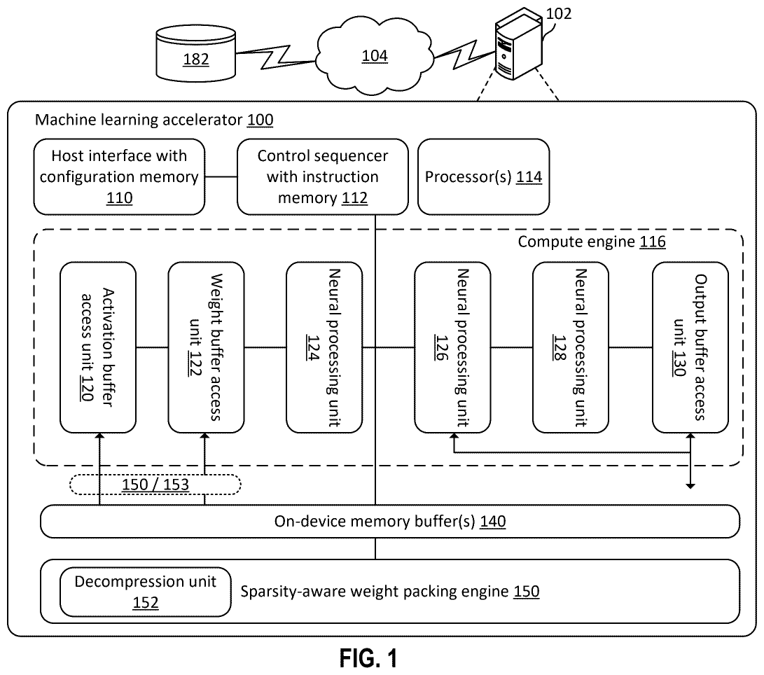

Hardware accelerators may include a class of specialized hardware accelerators designed to accelerate machine learning applications by focusing on arithmetic operations and in-memory computing capability. A neural network accelerator (NNA) architecture is an example of a machine learning accelerator hardware that has been designed to accelerate processing for neural networks. An example of a NNA is described below in reference to FIG. 1. A variety of different operations may be performed by a particular machine learning model during inference. As an example of machine learning operations (e.g., operations that may be optimized to improve performance using the various hardware and/or techniques described herein), a forward pass of a feed forward neural network is now described.

The forward pass involves a series of mathematical transformations that start at the input layer, propagate through one or more hidden layers, and culminate in the output layer. Input data, usually in the form of vectors (e.g., a numerical encoding of one or more inputs token representing words or sub-words, in the context of language models), is provided to the input layer of the model. In a fully-connected example, each neuron of the input layer is connected to each neuron of the subsequent first hidden layer. For each neuron of the input layer, the value is multiplied by a respective weight (a parameter learned during training). The weight value for a given input neuron is specific to that neuron's connection with a given neuron in the first hidden layer. For a given neuron in the first hidden layer, the weighted inputs are summed together and a bias term is added. The bias term allows the activation function to be shifted to the left or right (e.g., to be more negative or more positive). This summation result may be passed through an activation function (e.g., sigmoid, a rectified linear units (ReLu) function, tanh, etc.) to introduce non-linearity into the model. As described in further detail below, in various examples, the activation function may be used to introduce (or increase) sparsity in the resulting activation tensor. For example, ReLU activation induces over 90% sparsity (e.g., over 90% zero-values in a given activation tensor) in a feed forward network's intermediate outputs. In some other cases, sparsity may be introduced into the activation tensors using integer activation (e.g., quantizing the activation values into integers) and/or using other quantization techniques to force many activation values to zero. The resulting value is the activation value for the first neuron in the first hidden layer. This process is repeated for each neuron in the first hidden layer. Note that the weight values connecting nodes in the input layer may be different for each distinct neuron in the first hidden layer (and similarly for the connections between subsequent hidden layers and the output layer). The activation values for the neurons at the first hidden layer (and similarly for any hidden layer and the output layer) may be stored together in a data structure referred to herein as an activation tensor. In an activation tensor, each element may correspond to a neuron and the value of that element may be the current activation value for that neuron (generated for the current input). Since the inputs may be dynamic, these activation values change over time and are thus of dynamic sparsity. In contrast, the weight values, which may be conceptually thought of as the values of the connections between neurons, are static (post training) until the model is re-trained, and are thus of static sparsity. Some current LLM architectures include over a trillion learnable parameters. As such loading all of these parameters into random access memory (RAM) during processing involves loading a large amount of data into memory and involves a large number of multiplication and addition operations. The various sparse activation-aware techniques described herein may dynamically reduce the weight values that are required to be loaded into memory for a given input and may also reduce the required number of arithmetic operations being performed leading to huge improvements in memory footprint, compute, throughput, and power consumption.

Machine learning techniques, such as those described herein, can be used to form predictions, solve problems, answer questions, recognize objects in image data for classification, generate images, video, and/or natural language data, etc. In various examples, machine learning models may perform better than rule-based systems and may be more adaptable as machine learning models may be improved over time by retraining the models as more and more data becomes available. Accordingly, machine learning techniques can adapt to changing conditions.

Generally, in machine learning models, such as neural networks, after initialization, annotated training data may be used to generate a differentiable cost or “loss” function that describes the difference between expected output of the machine learning model and actual output. The parameters (e.g., weights and/or biases) of the machine learning model may be updated to minimize (or maximize) the cost. For example, the machine learning model may use a gradient descent (or ascent) algorithm to incrementally adjust the weights to cause the most rapid decrease (or increase) to the output of the loss function. The method of updating the parameters of the machine learning model is sometimes referred to herein as back propagation.

As previously described, the compute cost (in terms of compute resources used) for a given inference request may vary greatly depending on the complexity of the request and the particular machine learning model being deployed. Some examples of machine learning architectures which may be deployed for inference processing are now described. It should be noted that these examples do not constitute an exhaustive list and that the inference routing and/or complexity classification techniques described herein may be used with any desired machine learning model architectures.

### Language Models

A generative LM is an artificial intelligence (AI) model that may be capable of processing and generating human-like text based on the latent information it has learned from vast amounts of training data. In some cases, some LMs are referred to as “large” language models (LLMs). The term “large” refers to the size of these models in terms of the number of parameters or weights, which are the values that the model learns during training to make predictions and/or generate output such as text, synthesized speech, control instructions for control of other devices, etc. LMs may have millions, billions (or even more) parameters, which enable such models to capture complex patterns and nuances in language that, in turn, allow the models to process and generate more natural-sounding text (relative to previous approaches). LMs are typically trained on massive datasets that include a wide variety of text from various sources, enabling the LMs to “understand” grammar, context, and the relationships between words, sentences, paragraphs, etc. Examples of LMs include the generative pre-trained transformer models (e.g., GPT-3, GPT-4), Pathways Language Model (PaLM), Large Language Model Meta Artificial Intelligence (LLaMA), Claude by Antrhopic, as well as non-generative examples such as BERT (bidirectional encoder representations from Transformers), etc.

In a generative context, an LM may generate text that is responsive to the input prompt provided to the LM. LMs excel at generating natural sounding text that appears as though it has been generated by a native speaker in the relevant language. In addition to fluency, generative LMs are able to generate detailed, relevant, and largely accurate responses to input prompts in many cases due to the large amount of latent information the generative LM has learned during training. The term “prompt” may refer to plain text or structured text, and may be provided via an interface to the LM, such as an API. The prompt may generally be written in natural language, expressed, for example, as if requesting a task to be performed by the LM (e.g., “Who is the current President of the United States?”). In some examples, contextual information may be provided (e.g., as part of the prompt) and/or may be retrieved (e.g., from external sources) by the LM (e.g., retrieval-augmented generation (RAG)) and used to respond to the prompt). In some examples, LMs may be instructed (e.g., using hidden prompts) as to how to use various external APIs and/or tools (e.g., online search engines and/or other software) that may, in turn, be used to perform actions responsive to user-input requests. LMs are often built using the transformer architecture, which is described in further detail below. It should be noted, however, that transformers may be used in other machine learning contexts beyond LMs.

### Transformer Models

Transformer models are employed in many different types of machine learning architectures, including many of the LMs previously described. Transformer models are machine learning models that include an encoder network and a decoder network. The encoder takes an input (e.g., a “prompt”) and generates feature representations (e.g., feature vectors, feature maps, etc.) of the input. The feature representation is then fed into a decoder that may generate an output based on the encodings. In natural language processing, transformer models take sequences of words as input. A transformer may receive a sentence and/or a paragraph (or any other quantum of text) comprising a sequence of words as an input.

The encoder network of a transformer comprises a set of encoding layers that processes the input data one layer after another. Each encoder layer generates encodings (referred to herein as “tokens”). These tokens include feature representations (e.g., feature vectors and/or maps) that include information about which parts of the input data are relevant to each other. Each encoder layer passes its token output to the next encoder layer. The decoder network takes the tokens output by the encoder network and processes them using the encoded contextual information to generate an output (e.g., the aforementioned one-dimensional vector of tokens). The output data may be used to perform task-specific functions and/or generate a natural language response to the input (depending on the specific model being employed). To encode contextual information from other inputs (e.g., combined feature representation), each encoder and decoder layer of a transformer uses an attention mechanism, which for each input, weighs the relevance of every other input and draws information from the other inputs to generate the output. Each decoder layer also has an additional attention mechanism which draws information from the outputs of previous decoders, prior to the decoder layer determining information from the encodings. Both the encoder and decoder layers have a feed-forward neural network for additional processing of the outputs, and contain residual connections and layer normalization steps.

### Scaled Dot-Product Attention

The basic building blocks of the transformer are scaled dot-product attention units. When input data is passed into a transformer model, attention weights are calculated between every token simultaneously. The attention unit produces embeddings for every token in context that contain information not only about the token itself, but also a weighted combination of other relevant tokens weighted by the attention weights.

Concretely, for each attention unit the transformer model learns three weight matrices; the query weights W_{Q}, the key weights W_{K}, and the value weights W_{V}. For each token i, the input embedding xᵢ is multiplied with each of the three weight matrices to produce a query vector qᵢ=xᵢ W_{Q}, a key vector kᵢ=xᵢ W_{K}, and a value vector vᵢ=xᵢ W_{V}. Attention weights are calculated using the query and key vectors: the attention weight aᵢⱼ from token i to token j is the dot product between qᵢ and kⱼ. The attention weights are divided by the square root of the dimension of the key vectors, \sqrt{dₖ}, which stabilizes gradients during training. The attention weights are then passed through a softmax layer that normalizes the weights to sum to 1. The fact that W_{Q} and W_{K} are different matrices allows attention to be non-symmetric: if token i attends to token j, this does not necessarily mean that token j will attend to token i. The output of the attention unit for token i is the weighted sum of the value vectors of all tokens, weighted by aᵢⱼ, the attention from i to each token.

The attention calculation for all tokens can be expressed as one large matrix calculation, which is useful for training due to computational matrix operation optimizations which make matrix operations fast to compute. The matrices Q, K, and V are defined as the matrices where the ith rows are vectors qᵢ, kᵢ, and vᵢ respectively.

$$Attention ( Q , K , V ) = softmax ( \frac{Q {K}^{T}}{\sqrt{{d}_{k}}} ) V$$

### Multi-Head Attention

One set of (W_{Q}, W_{K}, W_{V}) matrices is referred to herein as an attention head, and each layer in a transformer model has multiple attention heads. While one attention head attends to the tokens that are relevant to each token, with multiple attention heads the model can learn to do this for different definitions of “relevance.” The relevance encoded by transformers can be interpretable by humans. For example, in the natural language context, there are attention heads that, for every token, attend mostly to the next word, or attention heads that mainly attend from verbs to their direct objects. Since transformer models have multiple attention heads, they have the possibility of capturing many levels and types of relevance relations, from surface-level to semantic. The multiple outputs for the multi-head attention layer are concatenated to pass into the feed-forward neural network layers.

Each encoder comprises two major components: a self-attention mechanism and a feed-forward neural network. The self-attention mechanism takes in a set of input encodings from the previous encoder and weighs their relevance to each other to generate a set of output encodings. The feed-forward neural network then further processes each output encoding individually. These output encodings are finally passed to the next encoder as its input, as well as the decoders.

The first encoder takes position information and embeddings of the input data as its input, rather than encodings. The position information is used by the transformer to make use of the order of the input data. In various examples described herein, the position embedding may describe an order of a sequence of words.

Each decoder layer comprises three components: a self-attention mechanism (e.g., scaled dot product attention), an attention mechanism over the encodings, and a feed-forward neural network. The decoder functions in a similar fashion to the encoder, but an additional attention mechanism is inserted which instead draws relevant information from the encodings generated by the encoders. In a self-attention layer, the keys, values and queries come from the same place—in the case of the encoder, the output of the previous layer in the encoder. Each position in the encoder can attend to all positions in the previous layer of the encoder. In “encoder-decoder attention” layers (sometimes referred to as “cross-attention”), the queries come from the previous decoder layer, and the keys and values come from the output of the encoder. This allows every position in the decoder to attend over all positions in the input sequence. The decoder is attending to the encoder features.

The foregoing examples of machine learning processing tasks are merely examples to show the diversity (in terms of both the task and the complexity) of machine learning techniques. However, the sparse activation aware hardware and techniques described herein may be used with any machine learning tasks.

FIG. 1 is a block diagram of an example machine learning accelerator 100 that may include a sparsity-aware weight packing engine 150, according to various embodiments of the present disclosure. In various examples, one or more computing devices 102 may include and/or be used to execute the machine learning accelerator 100 and/or components thereof. Additionally, the various components of the one or more computing devices 102 implementing machine learning accelerator 100 may be a collection of compute services that are distributed in a cloud-based environment. The components of machine learning accelerator 100 may communicate with one another and/or with remote computing devices (such as the various server instances discussed herein) via a network 104. Network 104 may be a wide area network, such as the Internet, an intranet, a local area network (LAN), and/or some combination thereof. Non-transitory computer-readable memory 182 may store instructions that, when executed by one or more processors of the one or more computing devices 102 may be effective to instantiate the various components of machine learning accelerator 100 and/or perform the various techniques described herein. In various examples, the memory 182 may be one or more persistent data stores that may store the weight tensors of one or more trained machine learning models. For example, the memory 182 may store weight tensors for an LLM being executing using, at least in part, the machine learning accelerator 100.

The machine learning accelerator 100 is one example instantiation of a hardware accelerator that may be used to perform highly-parallelized computations that may be typical of machine learning inference, training, and/or testing (e.g., matrix multiplication, tensor products, etc.). However, it should be noted that other types of accelerator hardware may also be used (and/or may be used in combination with the machine learning accelerator 100) in accordance with the present disclosure. For example, graphics processing units (GPUs), tensor processing units (TPUs), field-programmable gate arrays (FPGAs), neural processing units (NPUs), application-specific integrated circuits (ASICs), inference accelerators, etc., may be used in various server instance configurations described herein.

The machine learning accelerator 100 (e.g., a neural network accelerator, GPU, etc.) comprises a host interface 110, a control sequencer 112, an optional processor 114 (e.g., one or more CPUs with any number of cores), an activation buffer access unit 120, a weight buffer access unit 122, a plurality of neural processing units (NPUs) 124, 126, and 128, an output buffer access unit 130, a set of on-device memory buffers 140, and a sparsity-aware weight packing engine 150. The activation buffer access unit 120, the weight buffer access unit 122, the NPUs 124, 126, and 128, and the output buffer access unit 130 collectively form a compute engine 116. Along with the control sequencer 112 and the sparsity-aware weight packing engine 150, the compute engine 116 is responsible for executing instructions. Although a neural network accelerator (machine learning accelerator 100) is shown and described in the examples of FIG. 1, the sparsity-aware weight loading and inference optimization techniques described herein may be used with any machine learning hardware accelerator and/or with a general purpose processor (e.g., using software).

The machine learning accelerator 100 can be implemented as a standalone computing system or, as shown in FIG. 1, as part of a computing system comprising a host processor and system memory 182. The machine learning accelerator 100 depicted in FIG. 1 is merely an example and is not intended to unduly limit the scope of claimed embodiments. One of ordinary skill in the art would recognize many possible variations, alternatives, and modifications. For example, in some implementations, machine learning accelerator 100 may have more or fewer components than those shown in FIG. 1, may combine two or more components, or may have a different configuration or arrangement of components. The machine learning accelerator 100 generally executes one set of instructions at a time. This set of instructions is referred to herein as a “context.” At runtime, the machine learning accelerator 100 sequences and dispatches, using control sequencer 112, instructions from a pre-compiled context for execution. In certain embodiments, each context comprises a set of instructions that ends with a HALT instruction. Contexts are created by a software compiler. The instructions within a context can implement at least part of a neural network. For example, a context can correspond to a complete layer, a partial layer, or multiple layers of the neural network. In some instances, a context can correspond to a complete neural network (e.g., with instructions for an input layer, a hidden layer, and an output layer).

The host interface 110 is a communication interface to the host processor (not depicted) of the computing system. The computing system includes system memory for storing data operated on by the NNA (e.g., weights, activations, and output values corresponding to inferences). The machine learning accelerator 100 may be communicatively coupled to multiple hosts simultaneously, with any one of the hosts being able to program the machine learning accelerator 100 to execute neural network-related tasks on behalf of the host. The host interface 110 can communicate with the host processor via a standard communication protocol such as, for example, Advanced extensible Interface (AXI) protocol. Similarly, the machine learning accelerator 100 can include a separate communication interface for communicating with the system memory, e.g., to read and write data from the on-device memory buffers 140 to the system memory 182. The communication interface to the system memory 182 is, in certain embodiments, integrated into the sparsity-aware weight packing engine 150. Thus, the sparsity-aware weight packing engine 150 can also include an AXI interface.

The control sequencer 112 is responsible for sequencing, dispatching, and finishing execution of instructions. Some instructions are executed entirely in the control sequencer 112. Other instructions may be dispatched to one or more of the NPUs 124, 126, and 128 for execution, possibly with execution results being returned to the control sequencer 112 for further processing. Still other instructions are executed by the sparsity-aware weight packing engine 150 to move data to and from the on-device memory buffers 140 (e.g., DRAM). More than one instruction can be in the execution phase at any given time within the machine learning accelerator 100. The control sequencer 112 can include an instruction memory into which instructions to be executed by the machine learning accelerator 100 are downloaded from the host processor or loaded from the system memory. In the example of FIG. 1, the host interface 110 includes a configuration memory. The configuration memory may include one or more registers that are configurable by the host processor to specify parameters relating to the context to be executed, e.g., various context dependent parameter registers (CDPRs).

In certain embodiments, the configuration memory includes a predicate register for synchronizing execution of instructions. Instructions are broadcast by the control sequencer 112 to each component of the compute engine 116 as well as the on-device memory buffers 140 and the sparsity-aware weight packing engine 150. Upon receipt of a broadcast instruction, a component may proceed to execute at least part of the instruction in response to determining that the component is capable of handling the instruction. For example, the sparsity-aware weight packing engine 150 could receive and execute a data move instruction, but the NPUs 124, 126, and 128 could ignore the data move instruction. Because instructions can execute concurrently in different components, it is useful to have a synchronization mechanism to handle any dependencies between instructions. The predicate register can be used to implement such a synchronization mechanism and, in certain embodiments, is a global register visible to internal components of the machine learning accelerator 100, as well as visible to external entities such as the host processor. Synchronization also helps to prevent conflicts in accessing the on-device memory buffers 140.

The processor 114 is an optional general purpose processor for performing certain types of processing in parallel with processing performed by the NPUs 124, 126, and 128. For example, processor 114 may include a floating point unit or other arithmetic logic unit for performing general arithmetic operations in parallel with matrix operations performed by the NPUs 124, 126, and 128.

The activation buffer access unit 120 is configured to access one or more activation buffers in the on-device memory buffers 140. In various examples, the activation buffer access unit 120 may generate sparsity maps indicating the respective positions of zero values and non-zero values in a given activation tensor. In various other examples, the sparsity-aware weight packing engine 150 and/or another component may generate the sparsity maps via communication with activation buffer access unit 120. The sparsity-aware weight packing engine 150 may use the sparsity maps to load only those channels or portions of the weight tensor that pertain to non-zero activation values in order to reduce the amount of data transferred from system memory 182 to the on-device memory buffer(s) 140.

Similarly, the weight buffer access unit 122 and the output buffer access unit 130 are configured to access one or more weight buffers and one or more output buffers, respectively. The activations stored in the activation buffer(s) correspond to activations produced by one or more layers of a neural network being executed on the machine learning accelerator 100. The weights stored in the weight buffer(s) are synaptic weights (e.g., model parameters) associated with edges between a node of one layer and a node of another layer. Activation and weights are used for certain computations, including for instructions executed by the compute engine 116. The output buffers can store final results or intermediate results (e.g., partial sums) for access by the host processor or the system memory 182. The NPUs 124, 126, and 128 perform numerical operations using the activations and weights stored in the on-device memory buffers 140. Each NPU is configured to perform all or part of a compute instruction. Although FIG. 1 depicts the NPUs 124, 126, and 128 as block components, the NPUs 124, 126, and 128 are not necessarily identical. For example, the operations of one NPU may differ from the operations performed by another NPU.

The sparsity-aware weight packing engine 150 is used to bidirectionally move instructions and data between the system memory and NNA on-device memories (e.g., the activation, the weight, and output buffers that form the on-device memory buffers 140). The sparsity-aware weight packing engine 150 can receive data move instructions (e.g., LOAD and STORE instructions) from the control sequencer 112 when such instructions are broadcast. The data move instructions executed by sparsity-aware weight packing engine 150 can execute concurrently with compute instructions executed by the control sequencer 112 or the compute engine 116. As described herein, the sparsity-aware weight packing engine 150 may use sparsity maps to load only those channels or portions of the weight tensor that are needed to process non-zero activation values in the input activation tensor.

As shown in FIG. 1, the sparsity-aware weight packing engine 150 includes a decompression unit 152 that may be used to decompress weight data received from system memory 182 and optionally compressed using quantization aware training techniques. Quantization aware training may compress weight values (and/or other stored data of a model) into smaller representations. In various examples, the weights from system memory 182 may be decompressed into a format (e.g., 8-bit integer (“INT8”)) that is compatible with the neural network accelerator 100. In various examples, the location of the decompression unit 152 can vary. For example, in another embodiment, the decompression unit 152 (e.g., “in-line” decompression) can be part of the compute engine 116 and is configured to decompress data stored in the on-device memory buffers 140 for input of the decompressed data to one or more of the NPUs 124, 126, and 128. Optionally, on-the-fly decompression may be used (e.g., by optional decompression unit 153) to decompress weight values in on-device memory buffer(s) 140 when loading weight values into weight buffer access unit 122. Additionally, as described in further detail below, the sparsity-aware weight packing engine 150 may generate compressed versions of the activation tensors and the retrieved channels of the weight tensors. These compressed versions may be directly acted upon by the NPUs 124, 126, 128, etc., in order to reduce the number of required computations.

The decompression unit 152 implements a decompression pipeline. The decompression pipeline of the decompression unit 152 involves processing using one or more decompression schemes. The decompression unit 152 can select between using one decompression scheme alone or using multiple decompression schemes in combination. For example, the decompression unit 152 may decompress data using zero value decompression and then further decompress the data using shared value decompression. In the example of zero value plus shared value decompression, the order in which the compression schemes are applied can vary depending on how the decompression unit 152 is implemented. Thus, zero value decompression could be performed first followed by shared value decompression. Alternatively, shared value decompression could be performed first. In general, the order in which zero value decompression and shared value decompression are performed does not matter as the resulting decompressed data would be the same irrespective of which decompression scheme is applied first.

In the example of FIG. 1, the decompression unit 152 may be configured to receive compressed data from the system memory 182 and decompress the compressed data, using one or more decompression schemes, to generate decompressed data for storage in the on-device memory buffers. Alternatively, in certain embodiments, the decompression unit 152 may be configured to receive compressed data from the on-device memory buffers and decompress the compressed data for use by a processing component of the machine learning accelerator 100 (e.g., one of the NPUs 124, 126, and 128, or the control sequencer 112). Thus, the data may be stored in either compressed or decompress form within the on-device memory buffers 140. Irrespective of how the data is stored in the on-device memory buffers 140, the data may be sent from the system memory to the machine learning accelerator 100 in compressed form. Sending the data to the NNA in compressed form reduces the amount of time required to send the data.

The on-device memory buffers 140 are used to abstract the physical implementation of memories that form the activation, weight, and output buffers from NNA components (e.g., the compute engine 116 and the sparsity-aware weight packing engine 150) that access data in these buffers. The data in the activation, weight, and output buffers is accessed through addressing the buffers individually, with the buffer addresses being mapped to the physical addresses of the memories where the data is stored. In certain embodiments, the memories of the on-device memory buffers 140 are implemented as static random-access memory (SRAM) devices. However, the on-device memory buffers 140 can be implemented using other types of memory, both volatile and non-volatile (e.g., flash memory, DRAM, resistive RAMs, and the like). As mentioned above, the data in be stored in the on-device memory buffers 140 in compressed or decompressed form.

The NPUs 124, 126, and 128 perform numerical arithmetic operations using the activations and weights stored in the on-device memory buffers 140. Each NPU is configured to perform all or part of a compute instruction. The compute instruction may, for example, implement at least some of the computation described earlier in connection with processing by a node of a neural network, i.e., computing a weighted sum of input activations multiplied by weights, adding a bias value to the weighted sum, and then applying an activation function. Other types of computations may also be performed by the NPUs 124, 126, and 128. For example, identifying the minimum and maximum values among a first set of data values represented by a first vector and a second set of data values represented by a second vector, performing an extended multiply add, subtracting two vectors, and other types of operations applicable to data from a vector or matrix may be performed.

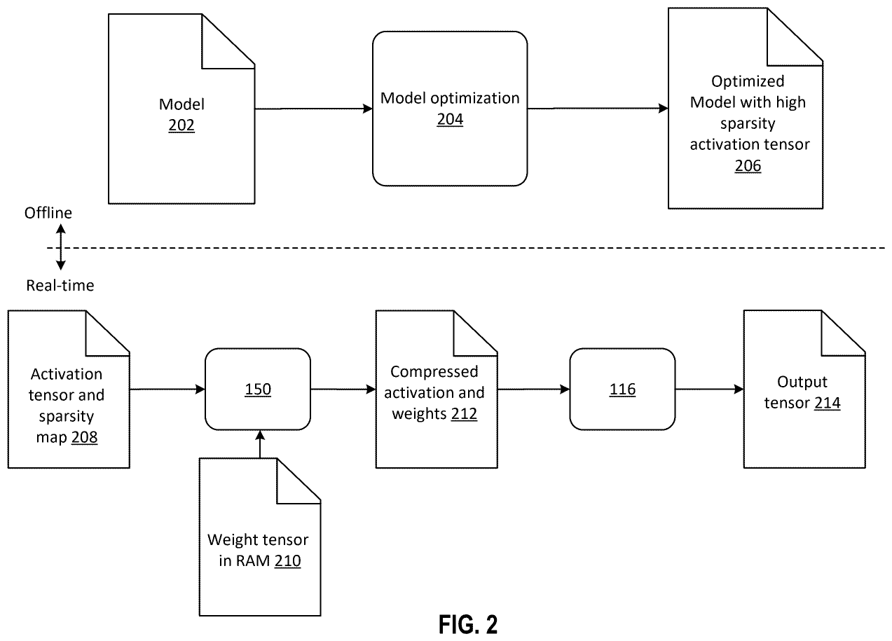

FIG. 2 depicts offline model optimization and real-time sparse activation aware processing for machine learning models, according to various aspects of the present disclosure. During the offline mode, the subject machine learning model (model 202) may be subjected to model optimization 204 (e.g., supervised training) to generate optimized model with high sparsity activation tensor 206. Note that while model optimization 204 does not require any specialized hardware, if the sparsity-aware weight packing engine 150 is used (as described below) the training process may be accelerated (due to fewer operations being necessary) which may conserve compute and power consumption and reduce training time. In instances where the process is executed on a general CPU (e.g., using pointer values for the relevant channels or portions of the weight tensor, as determined from the sparsity maps for the activation tensors), the processing (in both offline and real-time modes) may be accelerated as the matrices/tensors being employed during the various arithmetic operations are much smaller, as described in further detail below.

In the real-time mode, the activation tensor and sparsity map 208 may be provided to the sparsity-aware weight packing engine 150 (e.g., by the activation buffer access unit 120). As previously described, sparsity in activation tensors may be enforced using a rectifier activation function (e.g., ReLU), in which any signed values may be reduced to zero values to induce sparsity. In other examples, sparsity in the activation tensors may be enforced using low-bit quantization of activation values (e.g., integer activation, such as 4-bit integer activation).

The sparsity-aware weight packing engine 150 may be specialized hardware that outputs the sparsity map using the activation tensor. For example, the sparsity-aware weight packing engine 150 may include a hardware ReLU design that outputs both the activation tensor and the activation sparsity map. In other examples, the activation buffer access unit 120 may output both the activation tensor and the activation sparsity map. In various other examples, a supervised machine learning-based predictor may predict the sparsity map for a given input (for a given layer of the model). In various examples, the supervised machine learning-based predictor may be trained on a similar dataset (using ground truth sparsity map annotation). In another example, a real-time sparsity detection mechanism may be implemented in software to check the value of the activation tensor and output a corresponding sparsity map. A cost function of the machine learning-based predictor may enforce various constraints (such as a percentage of sparsity (e.g., a percentage of zero-valued elements) or non-sparsity (e.g., a percentage of non-zero-valued elements indicated in the predicted sparsity map). In addition, confidence values of a machine learning-based predictor may be used to abandon sparse activation-aware weight loading if the confidence in the predicted sparsity map is below a threshold value.

The sparsity-aware weight packing engine 150 may use the sparsity map to determine the appropriate channels of the weight tensor 210 (e.g., the channels of the weight tensor 210 that are associated with non-zero values in the activation tensor). The activation tensor and the weight tensor may be compressed (block 212) by removing unused weight channels (e.g., the channels of the weight tensor associated with zero-valued activation tensor elements) and by removing zero-valued activation tensor elements. Accordingly, the compute engine 116 may operate on reduced-size weight and activation tensors leading to reduced compute requirements and latency. The output tensor 214 may be used to generate the activation tensor for the next hidden layer of the machine learning model (or as the output vector if the next layer is the output layer).

In summary, the sparsity map of the activation tensor may be provided by sparsity-aware weight packing engine 150 during calculation of the activation tensor. Based on the sparsity map, the sparsity-aware weight packing engine 150 may load the required channels of the projection matrix weight tensor. The activation tensor may be compressed to include only non-zero elements (using the sparsity map). The compressed activation tensor and compressed projection matrix weight tensor may be sent to the compute engine 116 for a reduced size matrix multiplication.

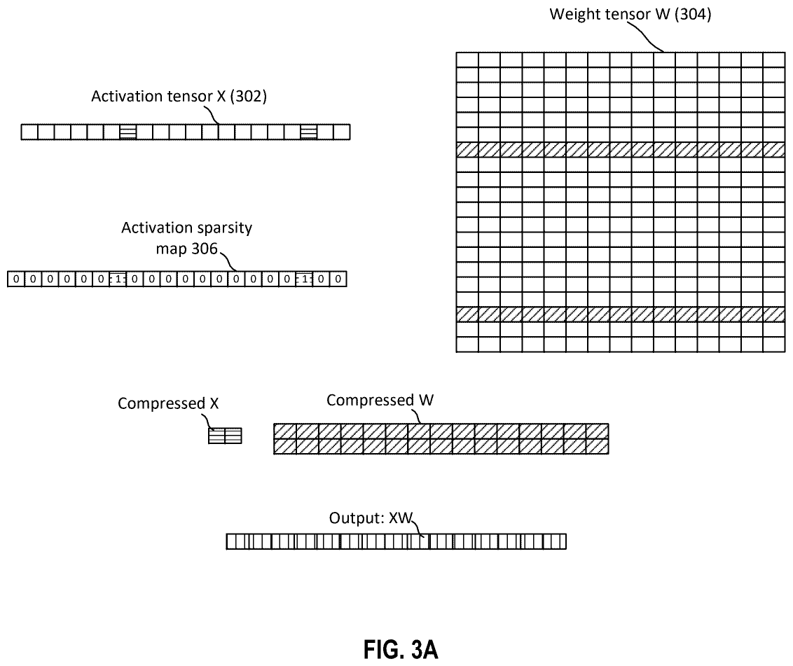

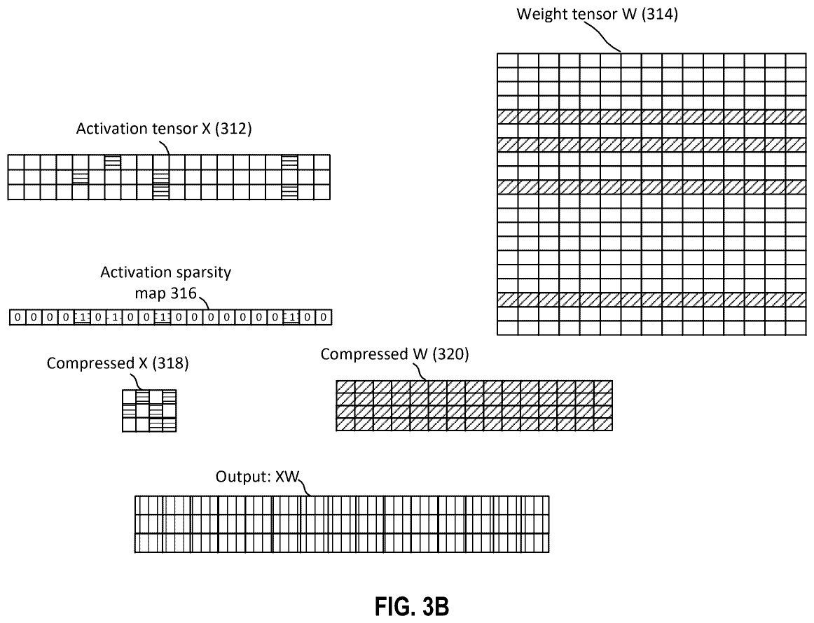

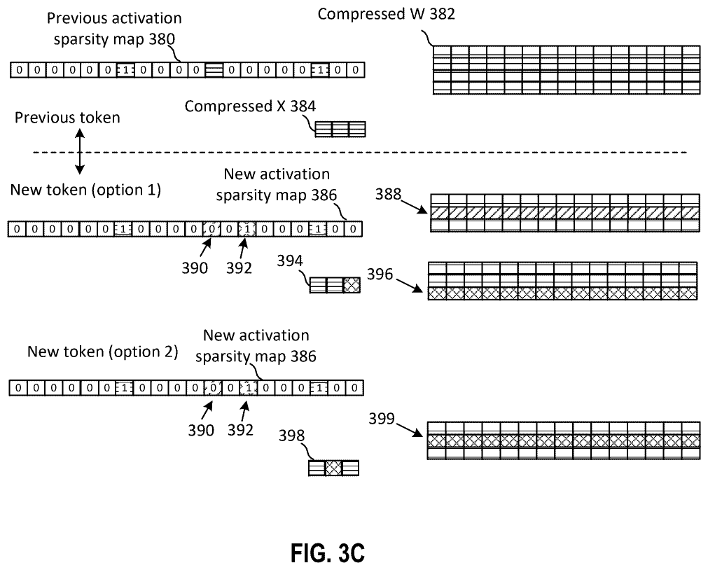

FIGS. 3A-3C depict various examples of sparse activation aware weight packing, in accordance with various examples of the present disclosure. FIG. 3A depicts an example for LLM processing where the input token length is 1. Therefore, the activation X∈R^{1×d} and projection matrix weight tensor W∈R^{d×m} (with m being used instead of d for generality). In the example, the activation tensor 302 is 90% sparsed. In other words, 90% of the elements of the activation tensor (in the example, 1-dimensional vector) are zero-valued. The corresponding channels of the projection matrix of the weight tensor 304 are shaded, for illustration. Accordingly, the only rows of the weight tensor 304 that contribute to downstream activation are the two shaded rows. As such, the projection weight matrix of the weight tensor 304 can be compressed based on the activation sparsity map 306 for the activation tensor 302. In the example of FIG. 3A, the activation tensor 302 is compressed to only non-zero values (shown in FIG. 3A as Compressed X). Similarly, the projection matrix of the weight tensor 304 is compressed to compressed W which includes only those weight channels that pertain to the non-zero values of the activation tensor 302. This reduces the dimensionality of the matrix multiplication from 1×20 vector (activation tensor 302) multiplied by a 20×15 matrix (weight tensor 304) to a 1×2 vector (Compressed X) multiplied by a 2×15 matrix (Compressed W) to generate the output XW. It should be noted that these example calculations are greatly simplified. In reality the dimensionality of the activation tensor 302 and the projection matrix of the weight tensor 304 may be orders of magnitude larger (typically including tens of thousands of elements, although the number is increasing as models grow larger). Channels of the weight tensor, in the context described herein, may refer to rows of the projection weight matrix W and the individual weight values of these rows. Accordingly, determining a product of an activation tensor and channels of the weight tensor refers to the matrix multiplication operation of the non-zero activation values of the activation tensor by the weight values in the channels of the projection weight matrix (and the corresponding summation operation used during matrix multiplication). As can be seen in the example in FIG. 3A, the amount of data to be moved from storage (e.g., system memory 182) to the on-device memory buffer(s) 140 (e.g., DRAM) is proportional to the sparsity rate of the activation tensor. In the example in FIG. 3A, the amount of memory to be moved is 90% less relative to conventional approaches.

FIG. 3B depicts another example for LLM processing where the input token length is 3 and each row of the activation tensor 312 corresponds to an individual token. Additionally, each row is 90% sparsed. The rows of weight tensor 314 that correspond to the non-zero values in the activation tensor 312 are shaded in FIG. 3B. Accordingly, the projection matrix of weight tensor 314 is 80% sparsed and only the four shaded rows are used during calculation of the activation tensor for the next layer of the LLM.

In this multi-token example, the activation sparsity map 316 includes a non-zero value if there is a non-zero value in the relevant column of the activation tensor 312. For example, there are no non-zero values in any of the first four columns of the activation tensor 312 (from left to right). Accordingly, the activation sparsity map 316 includes zeros in each of its first four elements. The fifth column of the activation tensor 312 includes a non-zero value in the second row. As such, the activation sparsity map 316 includes a binary 1 in the fifth element. The compressed version of the activation tensor (compressed X (318)) includes only columns of the activation tensor 312 that have non-zero elements and deletes columns with only zero elements. The compressed projection matrix of the weight tensor 314 (Compressed W (320)) includes only the channels of the projection matrix of the weight tensor 314 that are relevant to non-zero values of the activation sparsity map 316. Accordingly, as the activation sparsity map 316 includes “1” values in the fifth, seventh, tenth, and eighteenth elements, the compressed W (320) (i.e., the compressed projection matrix of the weight tensor 314) includes only the fifth, seventh, tenth, and eighteenth rows of the projection matrix of the weight tensor 314. Output XW represents the matrix multiplication result of Compressed X and Compressed W. Output XW may be used to calculate the activation tensor for the subsequent layer of the model (e.g., by subjecting the Output XW to an activation function (such as ReLU which may induce sparsity, as previously described)).

In various examples, weight channels of the weight tensor W (314) may be moved incrementally in order to achieve further efficiencies (e.g., in terms of reduced latency). For example, the first token of the activation tensor 312 implicates rows seven and eighteen of weight tensor 314. As such, the sparsity-aware weight packing engine 150 may load the seventh row weight channel (i.e., the weight values of the seventh row of the projection matrix of the weight tensor 314) and the eighteenth row weight channel into the on-device memory buffer(s) 140 (e.g., DRAM) and compute engine 116 may perform the matrix multiplication for the first token. While this computation is occurring, the fifth and tenth rows of the weight tensor 314 may be loaded for the second token of the activation tensor 312. Compressed W (320) may be remapped with the newly-loaded channels (i.e., the fifth and tenth rows) of the weight tensor 314. Again, compute engine 116 may perform the matrix multiplication for the second token using the second row of the activation tensor 312 and the fifth and tenth rows of the projection matrix of the weight tensor 314. Then, for the third token (i.e., the third row of the activation tensor 312), the implicated weight channels (i.e., the tenth and eighteenth channels) of weight tensor 314 have already been loaded into the on-device memory buffer(s) 140. As such, no data movement is required and compute engine 116 may perform the matrix multiplication for the third token using the third row of the activation tensor 312 and the tenth and eighteenth rows of the projection matrix of the weight tensor 314. Accordingly, output XW may be incrementally generated in order to reduce the amount of weight data being loaded at a given time and in order to maximize utilization of compute engine 116.

In some other examples, the projection matrix of the weight tensor W may be initialized as a matrix of zero values and W∈R^{d×m}. The rows (e.g., weight channels) implicated for computing all three rows of the activation tensor X may be moved into the on-device memory buffer(s) 140 (or the rows may be moved incrementally as described above and compute can occur while the corresponding weights for the next row are being loaded). FIG. 3C depicts another example for LLM processing where incremental weight movement is performed based on weights loaded for the previous token. In various examples, there may be a significant overlap between consecutive activation tensors. Therefore, if the previous compressed weight tensor is maintained in the on-device memory buffer(s) 140 (e.g., in DRAM) the weight channels used for processing the subsequent token may be used without requiring such weight channels to be re-loaded into the on-device memory buffer(s) 140. Instead, as shown in FIG. 3C, the differences between the activation sparsity map for the previous token and the current token may be used to determine how the compressed weight matrix W should be updated in order to maximize efficiency.

For example, for a previous token, the previous activation sparsity map 380 may have been used to generate the compressed activation tensor (compressed X 384) and to retrieve the appropriate weight channels to generate the compressed weight matrix (compressed W 382). The next token may have the new activation sparsity map 386. In the new activation sparsity map 386, element 390 indicates a zero value in the current activation tensor (not shown). This represents a change from a non-zero value (see element 12 of the previous activation sparsity map 380) to a zero value. Similarly, element 392 represents a change from a zero value (see element 14 of the previous activation sparsity map 380) to a non-zero value. In a first option, the row corresponding to element 390 may be deleted from the compressed W 382, as shown by the shaded row in the compressed W 388. Then, the newly-added row corresponding to element 392 may be appended to the end of the compressed W as shown in compressed W 396. Additionally, the newly added activation can be appended to the end of the compressed activation tensor 394, as shown.

In a second option (option 2), the non-required weight channels (corresponding to element 390 may be deleted from the compressed weight matrix and the newly-needed weight channel (corresponding to element 392) may be inserted into the compressed weight matrix to generate the compressed weight matrix 399. Similarly, the compressed activation tensor 398 may have the new activation value (corresponding to element 392) added in the corresponding position.

In the examples of FIG. 3C, the activation sparsity maps from previous tokens are saved in memory and are leveraged to increase efficiency. The examples described above illustrate storage of a single previous activation sparsity map. However, if the buffer (e.g., DRAM) capacity allows, more than one previous token sparsity activation map may be stored in memory and leveraged. For example, if three prior tokens are used, the overlap of the prior three token activation weights may be used instead of the “previous activation sparsity map 380” and the compressed activation tensor X (e.g., compressed X 384) may have zero-valued elements added for the additional weights being kept in the buffer. In various examples, the number of previous token sparsity maps to be stored in the buffer may be dynamic, depending on the amount of available capacity in the buffer.

Incremental Weight Movement from Activation Generation

As the previous layer output (i.e., the input activation tensor for the current layer) is being calculated, the output sparsity map may be monitored as it is being generated (e.g., one element or multiple elements at a time depending on the particular hardware design of the compute engine 116). When a non-zero element is generated in the output sparsity map, the corresponding weight channel may be loaded into the on-device memory buffer(s) 140 (e.g., DRAM). In this case, while the previous layer operation is being performed, weight channel movement into the on-device memory buffer(s) 140 has already begun for the subsequent layer increasing throughput and reducing latency.

### Dense-Dense/Dense-Sparse Matrix Compute Engine

After loading the compressed activation tensors and weight tensors into the on-device memory buffer(s) 140, either a dense-dense matrix compute engine 116 or a dense-sparse matrix compute engine 116 may be used. The dense-sparse matrix compute engine 116 may be employed in cases where the weight tensor is sparsed. In this case, dense-sparse matrix multiplication (SpMM) algorithms may be employed to gain efficiencies during computation. An example of such an algorithm is the Vision Transformer Acceleration via Dedicated Algorithm and Accelerator Co-Design (ViTCoD) when multiplying the compressed activation tensor X by the compressed sparsed weight matrix W.

An example compute flow for the compute engine 116 is described below:
1) Option 1 (No sparsity in the compressed weight tensor and one compute core): The dense-dense matrix compute may be performed.
2) Option 2 (Sparse compressed weight tensor and one compute core): The dense-sparse matrix compute may be performed. In this case, the weight tensor can be compressed using CMAP enabling a smaller data transfer to the buffers (e.g., reduced memory bandwidth).
3) Option 3 (No sparsity in the compressed weight tensor and multiple compute cores): The hardware may be designed such that all compute cores access the same DRAM (or other buffer) in order to enable higher compute rate via parallelism. In this case, the compressed weight tensors may be moved to the shared DRAM. Three example scenarios are described:
   a) Multi-token compute (for example in prompt processing, speculative decoding, etc.): In this case, each compute core may perform the compute of one activation channel (e.g., of one token).
   b) One-token compute (for example in token generation): In this case the activation tensor has only one channel. Then the compute of “compressed activation*compressed weigh tensors” can be divided between compute cores in different ways:
      i) Each core handles the compute of a subset of compressed weight values. For example, if there are two compute cores, the first core may perform “compressed activation*first half of compressed weight columns” and the second core may perform “compressed activation*second half of compressed weight columns.”
      ii) Each core handles the compute of a subset of activation tensors. For example, if there are two compute cores, the first core may perform “first half of compressed activation*first half of compressed weight rows” and the second core may perform “second half of compressed activation*second half of compressed weight rows.” Then, the results of the two cores may be aggregated together.
      iii) Combination of approaches i) and ii). For example, if there are four compute cores, the first core may perform “first half of compressed activation*top left quarter of compressed weight”, the second core may perform “second half of compressed activation*bottom left quarter of compressed weight rows”, the third core may perform “first half of compressed activation*top right quarter of compressed weight rows”, the fourth core may perform “second half of compressed activation*bottom right quarter of compressed weight rows.” Then, the results of the four cores may be appended and aggregated together.
      iv) There is no shared DRAM and each core has its own DRAM. In this example, each core may only move the subset of compressed weights that are required for the core. The compute may be similar to the above-described cases. Then, the results of all cores may be appended and aggregated as needed. In this case, each core uses much less data movement and the memory bandwidth for each core may be reduced to a fraction of memory bandwidth used during conventional approaches.
   c) Multi-token compute with each activation channel compute being performed by more than one core, similar to the previous (one-token compute) approach.
4) Option 4 (Sparse compressed weight tensor and multiple compute cores): This example combines options 2) and 3), where each core performs dense-sparse matrix compute (similar to option 2)).

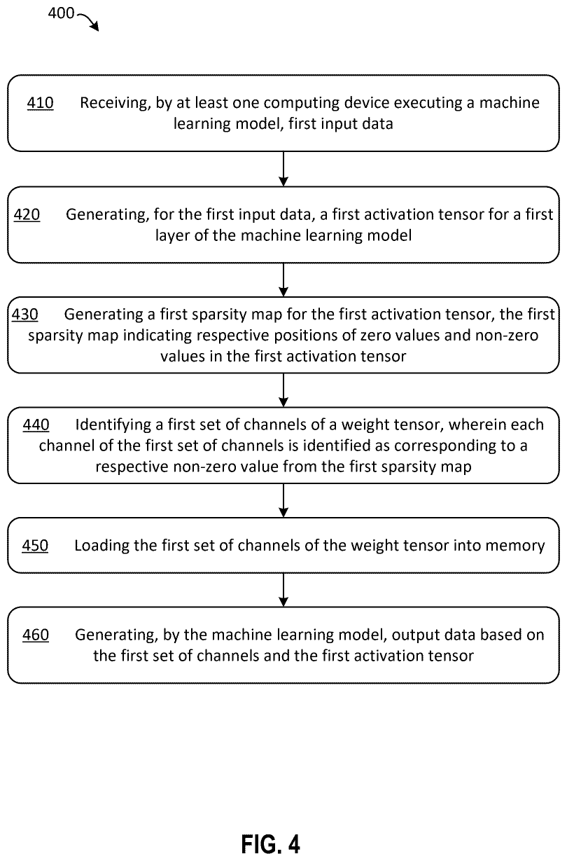

FIG. 4 depicts an example process 400 for sparse activation aware processing for machine learning models, in accordance with various aspects of the present disclosure. The actions of the process 400 may represent a series of instructions comprising computer readable machine code executable by a processing unit of an image signal processor, although various operations may be implemented in hardware. In various examples, the computer readable machine codes may be comprised of instructions selected from a native instruction set of the processor(s) and/or an operating system of the computing device.

Process 400 may begin at action 410, at which at least one computing device (e.g., one or more computing devices 102) executing a machine learning model may receive first input data. The particular form of the first input data may depend on the type of machine learning model being executed. For example, a computer vision model or image editing model may take image data and/or video data as input, while a generative language model may take text or speech as input. Various other machine learning models may take structured or unstructured data as inputs.

Processing may continue at action 420, at which a first activation tensor may be generated for the first input data. The first activation tensor may be generated for a first layer (e.g., a first hidden layer) of the machine learning model. The dimensionality of the first activation tensor may vary according to the first input data and/or the architecture of the machine learning model. In various examples, some degree of sparsity may be naturally present in the first activation tensor. In other examples, sparsity may be induced using low-bit integer activation, a rectifier activation function (e.g., ReLU), quantization, etc. For example, computer-executed logic may force all activation values below a threshold value to zero to ensure that greater than a threshold percentage of activations of the first activation tensor are zero-valued. In at least some examples, a sparsity map for a subsequent layer may be predicted (as described above) prior to the activation tensor input for that layer having been generated. For example, the sparsity map, for each layer of a model, may be predicted based on the first input data. In another example, the sparsity map for a second hidden layer (and/or subsequent hidden layers) of a model may be predicted while the activation tensor for a first hidden layer of the model is being computed (and based on the activation tensor for the first hidden layer). In general, information from activation tensors computed for prior hidden layers (and not only the hidden layer or input layer that is immediately prior) may be used to predict a sparsity map for a given layer.

In other examples, the sparsity map may be generated, in real time, as individual neuron activation values are being computed for the input activation tensor. In still other examples, hardware may be used to provide the sparsity map based on the input activation tensor (to reduce latency that may result from software-based approaches).

Processing may continue at action 430, at which a first sparsity map may be generated for the first activation tensor. The first sparsity map may indicate respective positions (e.g., respective elements of the activation tensor) of zero values and non-zero values in the first activation tensor. As previously described, the first sparsity map may be generated in near real-time as the previous layer's activation tensor (e.g., the first activation tensor in process 400) is being generated so that incremental weight packing may be used to retrieve relevant channels of the weight tensor and load them into DRAM (or other on-device memory). The first sparsity map may have an element corresponding to each element of the first activation tensor and the value of each element of the first sparsity map may be a binary value indicating whether the corresponding value of the first activation tensor is a zero value or a non-zero value.

Processing may continue at action 440, at which a first set of channels of a weight tensor (e.g., of a projection matrix of the weight tensor stored in system memory) may be identified using the first sparsity map. Each channel of the first set of channels may correspond to a non-zero value of the first sparsity map. In other words, the channels (e.g., rows) of the weight tensor that correspond to non-zero values in the first activation tensor may be loaded into memory (e.g., on-device memory buffer(s) 140).

Processing may continue at action 450, at which the first set of channels of the weight tensor may be loaded into memory (e.g., on-device memory buffer(s) 140). Channels of the weight tensor (e.g., of the projection matrix of the weight tensor) which correspond to zero values in the first activation tensor (as determined using the first sparsity map) may not be moved into DRAM (or other on-device memory buffer(s) 140) as such weight channels do not contribute to activations in the current layer of the model. As such, these weight channels may not be moved in order to reduce the amount data being moved into memory and to reduce the number of necessary computations performed to compute the current layer's activation tensor.

Processing may continue at action 460, at which output data may be generated based on the first set of channels and the first activation tensor. For example, compressed versions of the first activation tensor and the weight tensor may be generated using the first sparsity map. The compute engine 116 may determine the product of the compressed versions of the first activation tensor and the weight tensor. The activation tensor of the next layer of the machine learning model may be determined (e.g., after adding any bias term and subjecting the product output to an activation function (which may again induce sparsity)). These operations may be repeated at subsequent layers of the machine learning model (depending on the specific model architecture) until an output layer is reached. In various examples, the output data of action 460 may be the output data extracted from the last layer of the machine learning model. This output data may be used to perform a task-specific action (depending on the desired use case for the model). Examples may include token generation (for a generative LLM), image generation (e.g., for a latent diffusion model), classification, prediction, etc.

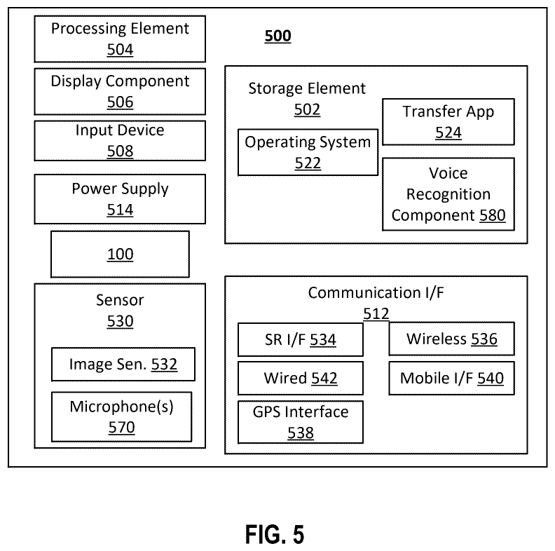

FIG. 5 is a block diagram showing an example architecture 500 of a network-connected device, such as a device that may include the machine learning accelerator 100. In various examples, it may be advantageous to deploy the machine learning accelerator 100 in network edge devices and/or resource constrained devices (such as a device including all or some portion of the components of architecture 500) as the machine learning accelerator 100 may lower computational requirements for model execution (e.g., for machine learning model inference).

It will be appreciated that not all devices will include all of the components of the architecture 500 and some user devices may include additional components not shown in the architecture 500. The architecture 500 may include one or more processing elements 504 for executing instructions and retrieving data stored in a storage element 502. The processing element 504 may comprise at least one processor. Any suitable processor or processors may be used. For example, the processing element 504 may comprise one or more digital signal processors (DSPs). In some examples, the processing element 504 may be effective to determine a wakeword and/or to stream audio data to a speech processing system. The storage element 502 can include one or more different types of memory, data storage, or computer-readable storage media devoted to different purposes within the architecture 500. For example, the storage element 502 may comprise flash memory, random-access memory, disk-based storage, etc. Different portions of the storage element 502, for example, may be used for program instructions for execution by the processing element 504, storage of images or other digital works, and/or a removable storage for transferring data to other devices, etc.

The storage element 502 may also store software for execution by the processing element 504. An operating system 522 may provide the user with an interface for operating the computing device and may facilitate communications and commands between applications executing on the architecture 500 and various hardware thereof. A transfer application 524 may be configured to receive images, audio, and/or video from another device (e.g., a mobile device, image capture device, and/or display device) or from an image sensor 532 and/or microphone 570 included in the architecture 500. In some examples, the transfer application 524 may also be configured to send the received voice requests to one or more voice recognition servers.

When implemented in some user devices, the architecture 500 may also comprise a display component 506. The display component 506 may comprise one or more light-emitting diodes (LEDs) or other suitable display lamps. Also, in some examples, the display component 506 may comprise, for example, one or more devices such as cathode ray tubes (CRTs), liquid-crystal display (LCD) screens, gas plasma-based flat panel displays, LCD projectors, raster projectors, infrared projectors or other types of display devices, etc. As described herein, display component 506 may be effective to display content determined provided by a skill executed by the processing element 504 and/or by another computing device. In some examples, the display component 506 and/or one or more speakers (not shown) may be effective to output an indication that unconsumed notifications (e.g., voice notifications) are pending. In some cases, there may be an indicator light effective to provide such an indication. In addition, speakers of the architecture 500 may output the voice notification audio upon receiving a user command to consume or “read” the voice notifications.

The architecture 500 may also include one or more input devices 508 operable to receive inputs from a user. The input devices 508 can include, for example, a push button, touch pad, touch screen, wheel, joystick, keyboard, mouse, trackball, keypad, light gun, game controller, or any other such device or element whereby a user can provide inputs to the architecture 500. These input devices 508 may be incorporated into the architecture 500 or operably coupled to the architecture 500 via wired or wireless interface. In some examples, architecture 500 may include a microphone 570 or an array of microphones for capturing sounds, such as voice requests. Voice recognition component 580 may interpret audio signals of sound captured by microphone 570. In some examples, voice recognition component 580 may listen for a “wakeword” to be received by microphone 570. Upon receipt of the wakeword, voice recognition component 580 may stream audio to a voice recognition server for analysis, such as a speech processing system. In various examples, voice recognition component 580 may stream audio to external computing devices via communication interface 512.

When the display component 506 includes a touch-sensitive display, the input devices 508 can include a touch sensor that operates in conjunction with the display component 506 to permit users to interact with the image displayed by the display component 506 using touch inputs (e.g., with a finger or stylus). The architecture 500 may also include a power supply 514, such as a wired alternating current (AC) converter, a rechargeable battery operable to be recharged through conventional plug-in approaches, or through other approaches such as capacitive or inductive charging.

The communication interface 512 may comprise one or more wired or wireless components operable to communicate with one or more other computing devices. For example, the communication interface 512 may comprise a wireless communication module 536 configured to communicate on a network, such as a computer communication network, according to any suitable wireless protocol, such as IEEE 802.11 or another suitable wireless local area network (WLAN) protocol. A short range interface 534 may be configured to communicate using one or more short range wireless protocols such as, for example, near field communications (NFC), Bluetooth, Bluetooth LE, etc. A mobile interface 540 may be configured to communicate utilizing a cellular or other mobile protocol. A Global Positioning System (GPS) interface 538 may be in communication with one or more earth-orbiting satellites or other suitable position-determining systems to identify a position of the architecture 500. A wired communication module 542 may be configured to communicate according to the USB protocol or any other suitable protocol.

The architecture 500 may also include one or more sensors 530 such as, for example, one or more position sensors, image sensors, and/or motion sensors. An image sensor 532 is shown in FIG. 5. An example of an image sensor 532 may be a camera configured to capture color information, image geometry information, and/or ambient light information.

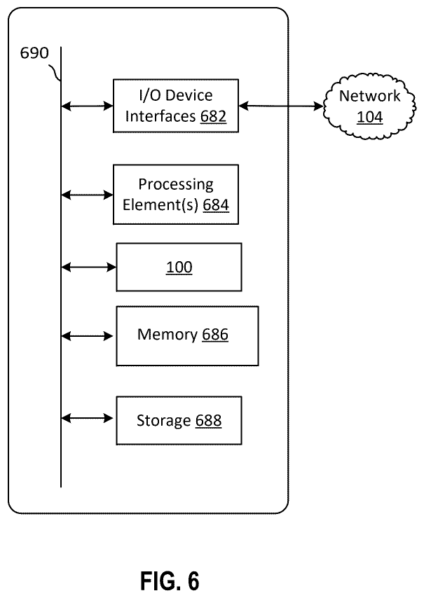

FIG. 6 is a block diagram conceptually illustrating example components of a computing device, such as the computing devices 102 and/or another computing device(s) implementing sparse activation-aware weight loading and inference for machine learning models, as described herein. In operation, each of these devices (or groups of devices) may include computer-readable and computer-executable instructions that reside on the respective device, as will be discussed further below.

Each computing device may include one or more controllers/processors 684, which may each include at least one central processing unit (CPU) for processing data and computer-readable instructions, and a memory 686 for storing data and instructions of the respective device. In at least some examples, memory 686 may store, for example, instructions effective to perform the various sparse activation-aware weight loading and inference described herein. In various further examples, memory 686 may be effective to store instructions effective to program controllers/processors 684 to perform the various techniques described above in reference to FIGS. 1-4. In addition, the machine learning accelerator 100 (including the sparsity-aware weight packing engine 150) may be instantiated in hardware in the system shown in FIG. 6. The memories 686 may individually include volatile random access memory (RAM), non-volatile read only memory (ROM), non-volatile magnetoresistive memory (MRAM), and/or other types of memory. Each device may also include a data storage component 688 for storing data and controller/processor-executable instructions. Each data storage component 688 may individually include one or more non-volatile storage types such as magnetic storage, optical storage, solid-state storage, etc. Each device may also be connected to removable or external non-volatile memory and/or storage (such as a removable memory card, memory key drive, networked storage, etc.) through respective input/output device interfaces 682. The architecture depicted in FIG. 6 may communicate with one or more other devices over network 104 (e.g., the Internet).

Computer instructions for operating each device and its various components may be executed by the respective device's controllers/processors 684, using the memory 686 as temporary “working” storage at runtime. A device's computer instructions may be stored in a non-transitory manner in non-volatile memory 686 (e.g., a non-transitory computer-readable memory), data storage component 688, or an external device(s). Alternatively, some or all of the executable instructions may be embedded in hardware or firmware on the respective device in addition to or instead of software.

Each device may include input/output device interfaces 682. A variety of components may be connected through the input/output device interfaces 682, as will be discussed further below. Additionally, each device may include an address/data bus 690 for conveying data among components of the respective device. Each component within a device may also be directly connected to other components in addition to (or instead of) being connected to other components across the bus 690.

Although various systems described herein may be embodied in software or code executed by general purpose hardware as discussed above, as an alternate the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon applying one or more data signals, application specific integrated circuits having appropriate logic gates, or other components, etc. Such technologies are generally well known by those of ordinary skill in the art and consequently, are not described in detail herein.

As used herein (e.g., including in the claims of the application), the terms “first”, “second”, and so forth, do not necessarily imply a particular order of events or elements, but are used to distinguish individual elements from one another. For example, the language a “first layer” of a machine learning model does not necessarily mean that the layer is the initial layer of the model. Instead, the adjective “first” may merely be intended to distinguish the layer from other layers such as a “second” layer. In fact, in various examples, the second layer may precede the first layer and there may be any number of intervening layers between the “first layer” and the “second layer.”

The flowcharts and methods described herein show the functionality and operation of various implementations. If embodied in software, each block or step may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processing component in a computer system. If embodied in hardware, each block may represent a circuit or a number of interconnected circuits to implement the specified logical function(s).

Although the flowcharts and methods described herein may describe a specific order of execution, it is understood that the order of execution may differ from that which is described. For example, the order of execution of two or more blocks or steps may be scrambled relative to the order described. Also, two or more blocks or steps may be executed concurrently or with partial concurrence. Further, in some embodiments, one or more of the blocks or steps may be skipped or omitted. It is understood that all such variations are within the scope of the present disclosure.

Also, any logic or other type of application described herein that comprises software or code can be embodied in any non-transitory computer-readable medium or memory for use by or in connection with an instruction execution system such as a processing component in a computer system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as magnetic, optical, or semiconductor media. More specific examples of a suitable computer-readable media include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described example(s) without departing substantially from the spirit and principles of the disclosure. All such modifications and variations are intended to be included herein within the scope of this disclosure and protected by the following claims.

What is claimed is:

1. A system comprising:
a neural network accelerator apparatus comprising
one or more processors;
one or more computer readable media storing processor executable instructions which, when executed using the one or more processors, perform operations comprising:
determining, based on first inference-time data and first weight data representing a first weight tensor, second inference-time data,
determining, based on the second inference-time data and an activation function, first activation data representing a first activation tensor,
determining, based on the first activation data and based on a first sparsity map indicating positions of non-zero values of the first activation tensor, compressed activation data representing a subset of values from the first activation tensor,
determining, based on second weight data representing a second weight tensor and based on the first sparsity map, compressed weight data representing a subset of values from the second weight tensor,
determining, based on the compressed activation data and the compressed weight data, third inference-time data.

2. The system of claim 1, wherein the one or more computer readable media store processor executable instructions which, when executed using the one or more processors, perform operations comprising
determining, based on the third inference-time data, machine learning model output.

3. The system of claim 2, wherein the system comprises an electronic device, and wherein the electronic device comprises the neural network accelerator apparatus, and wherein the one or more computer readable media store processor executable instructions which, when executed using the one or more processors, perform operations comprising
outputting, using one or more speakers of the electronic device, audio representing electronically generated speech based on the machine learning model output.

4. The system of claim 1, wherein the activation function is a rectified linear unit activation function.

5. The system of claim 1, wherein the one or more computer readable media store processor executable instructions which, when executed using the one or more processors, perform operations comprising
determining, based on the second inference-time data and an activation function, the first sparsity map.

6. A system comprising:
a neural network accelerator apparatus comprising
one or more processors;
one or more computer readable media storing processor executable instructions which, when executed using the one or more processors, perform operations comprising
determining, based on first inference-time data and first weight data representing a first weight tensor, second inference-time data,
determining, based on the second inference-time data and an activation function, first activation data representing a first activation tensor,
determining, based on the first activation data and based on a first sparsity map indicating positions of the activation tensor to be used for calculation, compressed activation data representing a subset of values from the first activation tensor,
determining, based on second weight data representing a second weight tensor and based on the first sparsity map, compressed weight data representing a subset of values from the second weight tensor,
determining, based on the compressed activation data and the compressed weight data, third inference-time data.

7. The system of claim 1, wherein the system comprises an electronic device including a speaker, wherein the electronic device includes the neural network accelerator apparatus, and wherein the first sparsity map indicates positions of non-zero values of the first activation tensor.

8. The system of claim 1, wherein the first sparsity map indicates estimated positions of non-zero values of the first activation tensor.

9. The system of claim 1, wherein the system comprises an electronic device including one or more device processors and one or more device computer readable media storing processor executable instructions which, when executed using the one or more device processors, cause the electronic device to perform operations comprising determining the first sparsity map.

10. The system of claim 1, wherein the one or more computer readable media store processor executable instructions which, when executed using the one or more processors, perform operations comprising:
determining, based on the second inference-time data and an activation function, the first sparsity map.

11. The system of claim 1, wherein the system comprises an electronic device including one or more device processors and one or more device computer readable media storing processor executable instructions which, when executed using the one or more device processors, cause the electronic device to perform operations comprising determining, based on the first activation data, the first sparsity map.

12. A method comprising:
generating a first sparsity map for a first activation tensor associated with a first layer of a first machine learning model, the first sparsity map indicating positions of non-zero values of the first activation tensor;
identifying a first set of channels of a weight tensor, wherein each channel of the first set of channels is identified as corresponding to a respective non-zero value from the first sparsity map;
loading the first set of channels of the weight tensor into memory; and
generating, by the first machine learning model, output data based on the first set of channels and the first activation tensor.

13. The method of claim 12, comprising generating the first activation tensor using a rectified activation function effective to generate at least a first percentage of zero-valued elements in the first activation tensor.

14. The method of claim 12, wherein the first activation tensor comprises a first row and a second row, the method comprising:
loading a first subset of the first set of channels of the weight tensor, the first subset of the first set of channels corresponding to non-zero values in the first row of the first activation tensor; and
computing first values of a second activation tensor based at least in part on a product of the first subset of the first set of channels and the first row of the first activation tensor.

15. The method of claim 14, comprising:
after computing the first values of the second activation tensor, loading a second subset of the first set of channels of the weight tensor, the second subset of the first set of channels corresponding to non-zero values in the second row of the first activation tensor; and
computing second values of the second activation tensor based at least in part on a product of the second subset of the first set of channels and the second row of the first activation tensor.

16. The method of claim 12, comprising generating a compressed representation of the first activation tensor by removing zero-valued elements, wherein the zero-valued elements are determined using the first sparsity map.

17. The method of claim 12, comprising:
generating a compressed weight tensor consisting of the first set of channels; and
determining a second activation tensor for a second layer of the first machine learning model based on a product of the compressed weight tensor by a compressed representation of the first activation tensor.

18. The method of claim 12, comprising:
generating a first compressed weight tensor based on the first set of channels;
storing the first compressed weight tensor and the first sparsity map in memory, wherein the first sparsity map is associated with a first token of first input data;
generating a second activation tensor for a second token of the first input data;
generating a second sparsity map for the second token;
determining a difference between the first sparsity map and the second sparsity map; and
generating a second compressed weight tensor by modifying the first compressed weight tensor based on the difference between the first sparsity map and the second sparsity map.

19. The method of claim 18, comprising:
determining a third activation tensor based on a product of the second compressed weight tensor and the second activation tensor; and
determining the output data further based on the third activation tensor.

20. The method of claim 18, comprising:
determining a first non-zero element of the first sparsity map that corresponds to a zero element of the second sparsity map, wherein the generating the second compressed weight tensor by modifying the first compressed weight tensor comprises deleting a channel of the first compressed weight tensor that corresponds to the zero element of the second sparsity map.
